(19) United States
(12) Patent Application Publication
(10) Pub. No.: US 2026/0064841 A1
(43) Pub. Date: Mar. 5, 2026

(54) AI MODEL-BASED DATA ENRICHMENT PIPELINE

(71) Applicant: CrowdStrike, Inc., Sunnyvale, CA (US)

(72) Inventors: Diana Bolocan, Iasi (RO); Mihaela-Petruta Gaman, Bucharest (RO)

(21) Appl. No.: 18/819,747

(22) Filed: Aug. 29, 2024

(51) Int. Cl. G06F 21/56; G06F 21/55

(52) U.S. Cl. CPC G06F 21/564; G06F 21/552; G06F 2221/033

(57) ABSTRACT

The present disclosure provides an approach of generating a request to obtain information corresponding to a data sample. The approach produces, by a processing device, sample metadata using an artificial intelligence (AI) model trained to analyze the data sample and generate the sample metadata. In turn, the approach enriches the data sample based on the sample metadata to produce an enriched data sample.

### TECHNICAL FIELD

Embodiments of the present disclosure relate to cybersecurity, and more particularly, to an artificial intelligence (AI) model-based data enrichment pipeline for cybersecurity applications.

### BACKGROUND

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing mathematical and computational frameworks used to extract patterns and insights from data. Large language models (LLMs), a category within machine learning models, are trained on vast amounts of text data to capture the nuances of language and context. By combining advanced machine learning techniques with enormous datasets, large language models harness data-driven approaches to achieve highly sophisticated language understanding and generation capabilities. AI models include machine learning models, large language models, and other types of models that are based on neural networks, genetic algorithms, expert systems, Bayesian networks, reinforcement learning, decision trees, or combination thereof.

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

Data curation refers to the process of organizing, managing, and enhancing data to ensure its quality, accuracy, and usability for a particular purpose or use-case, often involving activities such as data cleaning, data enrichment, data validation, and documentation. Data curation may be a preliminary step when dealing with imperfect data sources prone to noise to enhance the quality of the data corpus, ensuring the data corpus meets the particular requirements of a target use-case.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for data enrichment in accordance with some embodiments of the present disclosure.

FIG. 2 is a flow diagram of a method for enriching a data sample with sample metadata in accordance with some embodiments of the present disclosure.

FIG. 3 is a flow diagram of a method for validating sample metadata and using the validated sample metadata for subsequent inquiries in accordance with some embodiments of the present disclosure.

FIG. 4 is a block diagram that illustrates an example system for enriching a data sample with sample metadata in accordance with some embodiments of the present disclosure.

FIG. 5 is a block diagram of an example computing device that may perform one or more of the operations described herein in accordance with some embodiments of the present disclosure.

### DETAILED DESCRIPTION

As discussed above, data curation includes activities such as data cleaning, data enrichment, data validation, and documentation. Data enrichment involves augmenting existing information with missing or incomplete metadata. Traditional data enrichment techniques for supplementing missing or incomplete metadata in a corpus include aggregating internal and external data sources and automated text preprocessing. A challenge found, however, is that these approaches come with certain limitations such as third-party metadata aggregation, web-scraped open-source datasets, or internally-sourced data. Regarding third-party metadata aggregation, gathering metadata from third-party sources is subject to availability and often involves additional costs and contractual agreements between parties. Furthermore, preprocessing and aggregating metadata from disparate sources introduces additional overhead, complicating the enrichment process.

Another approach to externally-sourced data is the use of web-scraped open-source datasets. However, a challenge found with this approach is that these datasets often contain poorly structured, incomplete, and incorrect information. This necessitates data curation by specialized users to remediate errors, filter out inaccuracies, and translate the data into a compatible structure, which can be time-consuming and resource-intensive. Regarding internally-sourced data, a challenge found is that, while in-house data can be used to generate a more complete dataset, it is often insufficient to fully achieve the desired end goal because the internal datasets may lack the breadth and depth needed to cover all embodiments of a target use-case.

The present disclosure addresses the above-noted and other deficiencies by using an AI model-based pipeline as a cost-effective, integrable, and comprehensive solution for data enrichment. The approach leverages advanced AI techniques to streamline the enrichment process, reduce dependency on external sources, and improve the overall quality and completeness of the metadata to enrich the data.

In some embodiments, a processing device generates a request to obtain information corresponding to a data sample. The processing device produces sample metadata by providing the request to an AI model (e.g., with text generation capabilities) that is trained to analyze the data sample and generate the sample metadata. In turn, the processing device enriches the data sample with the sample metadata. In some embodiments, the data enrichment involves translating the sample metadata to tags and linking the tags to the data sample.

In some embodiments, the processing device validates the sample metadata to produce a validated sample metadata. The processing device then stores the validated sample metadata in a storage area. In some embodiments, the processing device then receives an inquiry to generate a subsequent request to provide subsequent information corresponding to a subsequent data sample. The processing device determines whether the subsequent data sample corresponds to the validated sample metadata. In response to determining that the subsequent data sample corresponds to the validated sample metadata, the processing device provides the validated sample metadata as a response to the inquiry. In some embodiments, the validated sample metadata includes a first hash corresponding to the data sample. As part of the determination operation, the processing device identifies a second hash corresponding to the subsequent data sample and then determines whether the first hash matches the second hash.

In some embodiments, the processing device trains the AI model (e.g., a generative AI model) utilizing the validated sample metadata. In some embodiments, the sample metadata includes structured data in tabular form. In some embodiments, the data sample corresponds to a malicious data sample detected by a cybersecurity system.

As discussed herein, the present disclosure provides an approach that improves the operation of a computer system by using an AI model-based pipeline to generate and integrate sample metadata, thereby enhancing the quality and completeness of data samples in a cost-effective and efficient manner. In addition, the present disclosure provides an improvement to the technological field of data enrichment by leveraging advanced AI techniques to streamline the enrichment process, reduce dependency on external data sources, and improve the overall efficacy of AI-powered products and services.

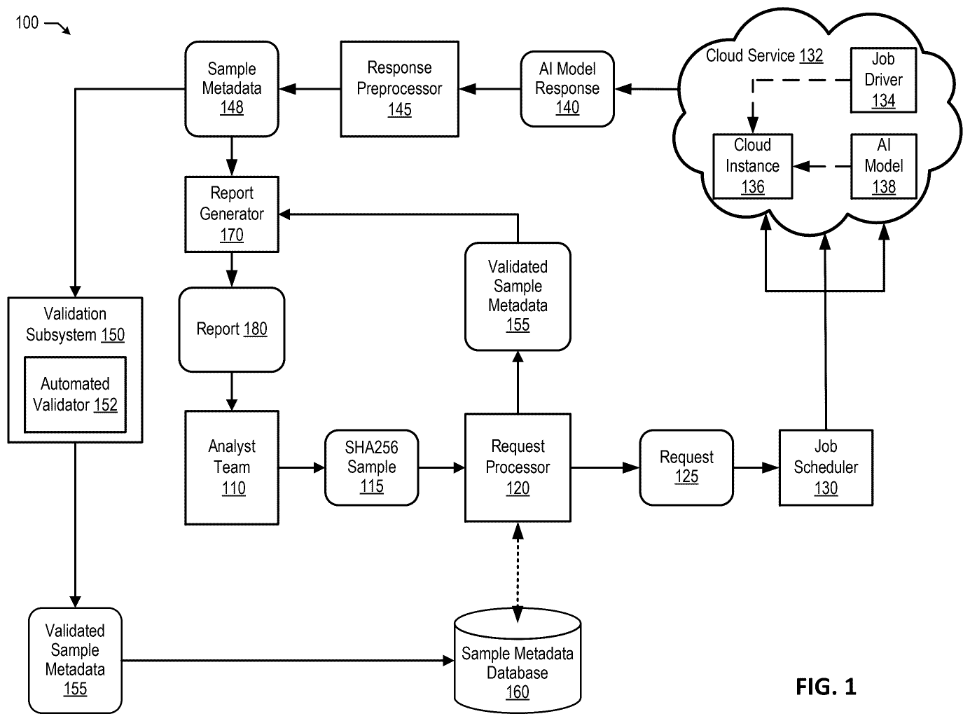

FIG. 1 is a block diagram that illustrates an example system for data enrichment in accordance with some embodiments of the present disclosure. System 100 includes an AI-based data enrichment pipeline that enriches cybersecurity-based data. The AI-based data enrichment pipeline includes request processor 120, job scheduler 130, cloud service 132, response preprocessor 145, report generator 170, and validation subsystem 150.

Analyst team 110 is responsible for evaluating data samples (e.g., files, emails, etc.) and uses the AI-based data enrichment pipeline to obtain additional information (e.g., metadata) about a data sample. To obtain additional information, analyst team 110 produces a secure hash algorithm 256 (SHA256) unique identifier (sample 115) corresponding to the data sample and provides SHA256 sample 115 to request processor 120.

Request processor 120 receives SHA256 sample 115 and determines whether a previous request for the same information has occurred to reduce the amount of inquiries to cloud service 132 because, in one embodiment, processing an inquiry within cloud service 132 is likely to be expensive and slow relative to other processes discussed herein. As discussed below, when request processor 120 receives SHA256 sample 115, request processor 120 checks whether a corresponding validated sample metadata is stored in sample metadata database 160. If so, request processor 120 sends the stored validated sample metadata 155 to report generator 170 accordingly. However, if sample metadata database 160 does not include corresponding validated metadata, request processor 120 generates request 125. In one embodiment, to determine whether a matching validated sample metadata 155 exists in sample metadata database 160, request processor 120 performs sample deduplication via unique identification matching (e.g., SHA256). In one embodiment, request processor 120 performs near-deduplication using sample content collisions. In one embodiment, request processor 120 performs clustering for both deduplication and metadata inheritance based on similarity levels.

Request processor 120 sends request 125 to job scheduler 130. Request 125 includes instructions that request information based on the content of the data sample (e.g., email, script, etc.), model parameters, and other information needed for cloud service 132 to process request 125. Job scheduler 130 assists with keeping operations cost effective. Instances required for processing are up and running as long as they are needed to finish a job. Upon completion, the resources are deallocated. Job scheduler 130 reduces usage of the network by automatically scheduling and allocating resources for requests in order to ensure that processing instances run when requests are to be handled and that the processing instances cease to run when the requests are processed.

Job scheduler 130 allocates resources in cloud service 132 (e.g., network resources) for request 125 based on receiving request 125. Subsequent to scheduling the job for request 125, job scheduler 130 provides (e.g., transmits) request 125 to cloud service 132. Job driver 134 of cloud service 132 may generate a cloud instance 136 in cloud service 132. For example, cloud instance 136 may be a virtual machine in the cloud. Cloud instance 136 executes an AI model 138 (e.g., a large language model (LLM)). In one embodiment, AI model 138 may have cybersecurity understandings and may be prompted such that the responses return metadata regarding samples. In one embodiment, AI model 138 may be fine-tined with additional data to help ensure metadata generation over provided samples. AI model 138 may also be configured to achieve language generation and other natural language processing (NLP) tasks such as classification by learning statistical relationships from text documents during a computationally intensive self-supervised and semi-supervised training process. In one embodiment, the AI model 138 is a publicly available, general-purpose LLM. In one embodiment, AI model 138 may execute on a device (e.g., a server computing device) of an organization that manages the cybersecurity systems.

AI model 138 produces AI model response 140 based on information included in request 125. In one embodiment, AI model response 140 includes structured data (e.g., tabular data) that describes the data sample. AI model response 140 may include keywords (e.g., 2-3 words), file names, dependencies, command iterations used to prevent attacks, etc. In one embodiment, AI model 138 is fine-tuned and/or trained on cybersecurity data, with an end-goal of completing tasks in the static and dynamic analysis space. In one embodiment, request 125 includes prompting as a request for structural output (e.g. JavaScript Object Notation (JSON) format) generation. In one embodiment, AI model response 140 includes one or more of MITRE TTPs (Tactics, Techniques and Procedures) (e.g., IDs and names); suspicious or malicious imports of dependencies; suspicious or malicious usage of commands and operations; hardcoded strings of interest (e.g. Uniform Resource Locators (URLs))—a decoded variant in case they present any type of encoding (e.g. Base64); types of script obfuscation (e.g. string operations, string encodings, paddings, etc.); Ips, Hardware Identifications (HWIDS), personal computer (PC) names, usernames, passwords, emails which can also be used for both profiling attackers and Personally Identifiable Information (PII) scrubbing; attack-specific capabilities such as self-spreading, sandbox evasion, etc. ; malware families, classes and behaviors (including co-occurring malware families and naming standardization); files, paths, applications and file extensions targeted by the attack; data type identification for challenging settings such as nested scripting languages (e.g. a Python script executing Bash commands); or a list of devices targeted by the attack (e.g., a script designed to run only on a particular operating system).

Response preprocessor 145 formats AI model responses 140 into a standard format, such as a tabular form, and produces sample metadata 148. In one embodiment, sample metadata 148 is produced by cloud service 132 and response preprocessor 145 may be bypassed. Response preprocessor 145 sends sample metadata 148 to report generator 170, where report generator 170 generates a corresponding report 180 (discussed below).

Response preprocessor 145 also sends sample metadata 148 to validation subsystem 150. Validation subsystem 150 includes automated validator 152, which validates sample metadata 148 to ensure that sample metadata 148 is both correct and complete. For example, some AI models (e.g., LLMs) may generate a response that is factually incorrect, nonsensical, or disconnected from an input prompt. Such a response may be referred to as a “hallucination. ” If sample metadata 148 is invalid, the system may discard the sample metadata 148. In one embodiment, automated validator 152 performs the validation based on a set of rules or based on a machine learning model. In one embodiment, automated validator 152 may perform Retrieval-Augmented Generation (RAG) where similar samples should have similar metadata. In one embodiment, automated validator 152 may perform Chain-of-Verification (CoVe) to verify that the returned metadata through a list of self-generated questions. In one embodiment, automated validator 152 may perform log probability-based measurements to indicate when a model is not confident (e.g., lower confidence correlates to a higher chance of hallucinating). Additionally, or alternatively, a response team member may manually inspect sample metadata 148 on a computing device to ensure that sample metadata 148 is valid.

Upon successful validation, validation subsystem 150 saves validated sample metadata 155 into sample metadata database 160. As such, the next time that analyst team 110 sends subsequent SHA256 sample 115's, request processor 120 determines which samples have already had their corresponding metadata retrieved and, in turn, retrieves their corresponding validated sample metadata (e.g., validated sample metadata 155) from sample metadata database 160 instead of sending another request 125 to job scheduler 130. In turn, request processor 120 sends the stored validated sample metadata 155 to report generator 170. In one embodiment, automated validator 152 acts as a pre-operation in fine-tuning AI model 138, as validated sample metadata 155 may be retrieved from sample metadata database 160 and used to improve AI model 138.

Report generator 170 aggregates sample metadata results into a single standardized format to generate report 180, which may vary based on the type of metadata received and typically includes general information about the data samples that were reviewed (e.g., JSON format). In one embodiment, a detailed tabular description of sample metadata reduces the amount of preprocessing steps, such as a similarity search. In one embodiment, report generator 170 enriches data samples by translating the metadata to tags and linking the tags to the data sample.

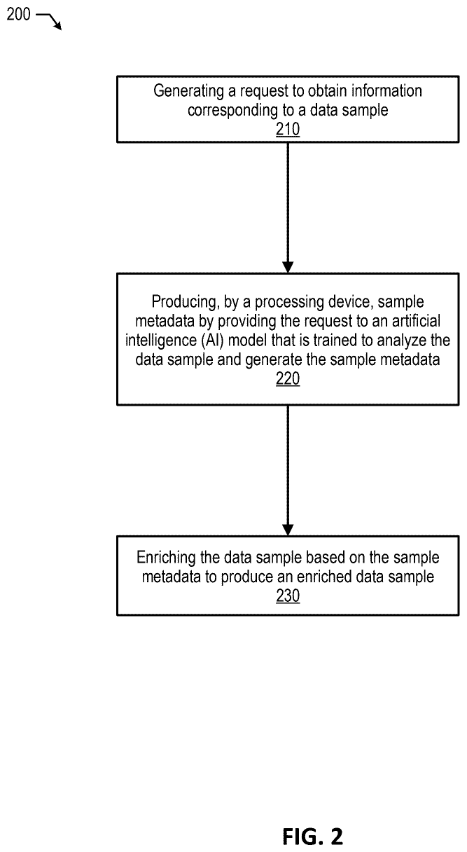

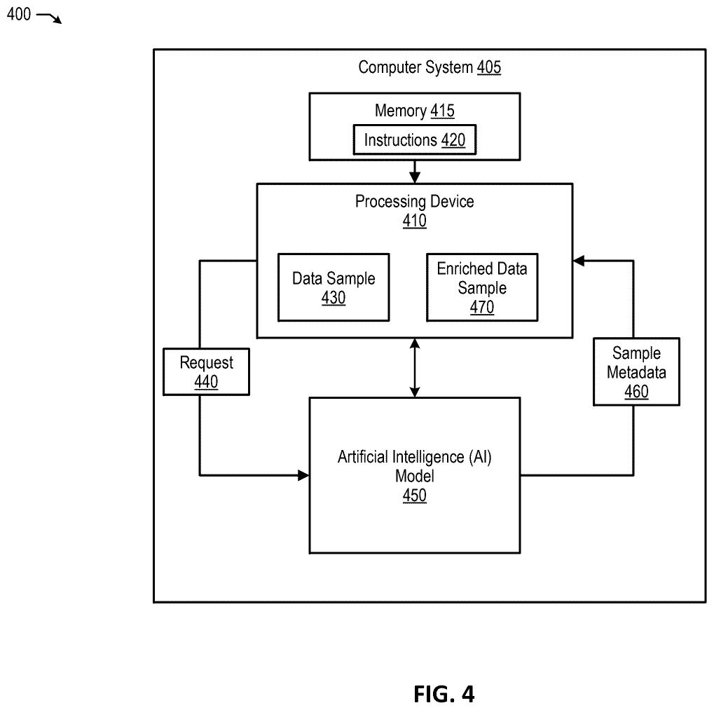

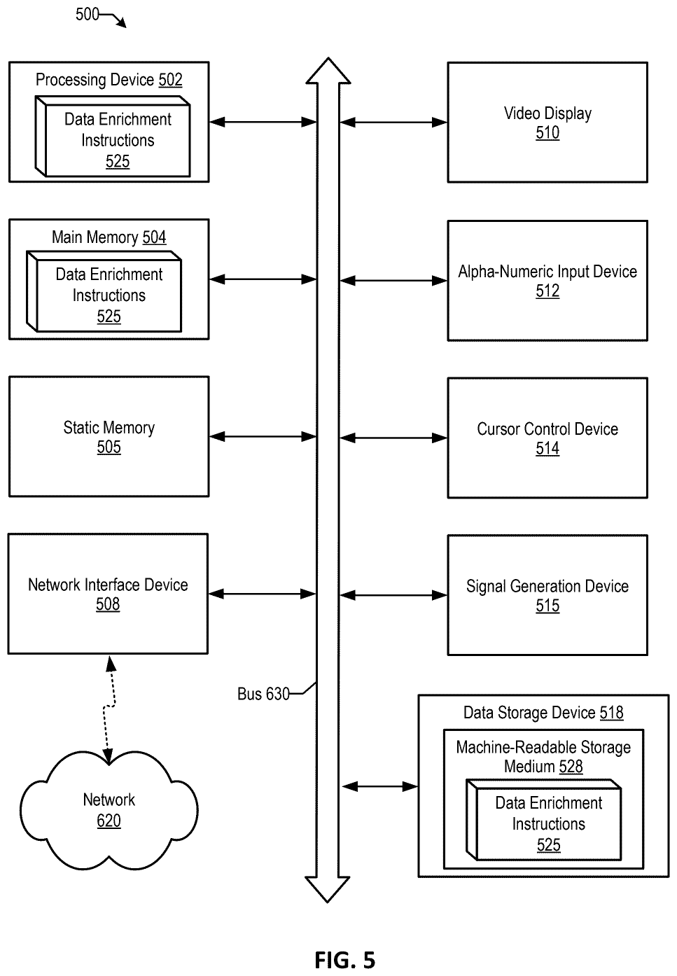

FIG. 2 is a flow diagram 200 of a method for enriching a data sample with sample metadata in accordance with some embodiments of the present disclosure. The method may be performed by processing logic that may include hardware (e.g., a processing device), software (e.g., instructions running/executing on a processing device), firmware (e.g., microcode), or a combination thereof. In some embodiments, at least a portion of the method may be performed by AI model 138, request processor 120, report generator 170 (shown in FIG. 1), processing device 410 (shown in FIG. 4), processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 210, processing logic generates a request to obtain information corresponding to a data sample. In one embodiment, the request is generated in response to receiving an inquiry that includes a SHA256 hash of the data sample. In one embodiment, the data sample corresponds to a malicious data sample from a cybersecurity system.

At block 220, processing logic produces sample metadata by providing the request to an artificial intelligence (AI) model trained to analyze the data sample and generate the sample metadata. In one embodiment, the sample metadata includes structured data in tabular form.

At block 230, processing logic enriches the data sample using the sample metadata. In one embodiment, processing logic enriches the data sample by translating the sample metadata to tags and linking the tags to the data sample.

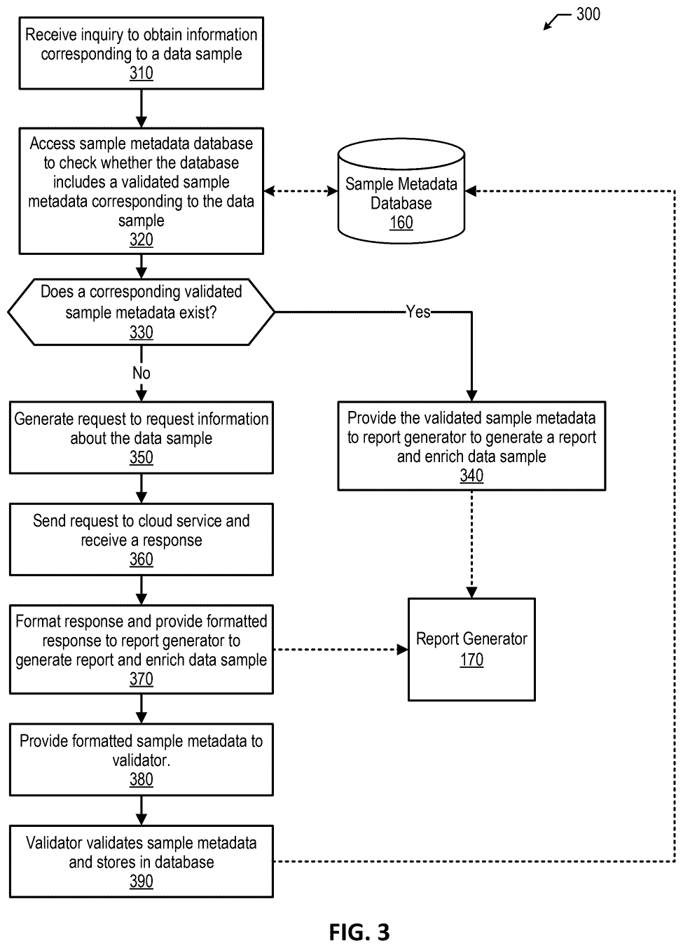

FIG. 3 is a flow diagram 300 of a method for validating sample metadata and using the validated sample metadata for subsequent inquiries in accordance with some embodiments of the present disclosure. The method may be performed by processing logic that may include hardware (e.g., a processing device), software (e.g., instructions running/executing on a processing device), firmware (e.g., microcode), or a combination thereof. In some embodiments, at least a portion of the method may be performed by AI model 138, request processor 120, report generator 170 (shown in FIG. 1), processing device 410 (shown in FIG. 4), processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 310, processing logic receives an inquiry to obtain information corresponding to a data sample. For example, analyst team 110 may provide a SHA256 sample 115 to request processor 120.

At block 320, processing logic accesses sample metadata database 160 to check whether the database includes a validated sample metadata from a previous inquiry. In one embodiment, request processor 120 automatically filters inquiries and generates requests. By filtering requests, the request processor reduces the number of requests 125 send to job scheduler 130 and reduces the report generation time by report generator 170. To filter the inquiries, request processor 120 may query sample metadata database 160 to check if a pivot sample already went through the enrichment procedure. Request processor 120 may also perform deduplication or near-deduplication via unique identification matching (e.g., SHA256) or sample content collisions to remove duplicate records so that unique instances of each data sample is retained. Request processor 120 may perform clustering for both deduplication and metadata inheritance based on similarity level.

At block 330, processing logic determines whether a corresponding validated sample metadata exists in sample metadata database 160. If a corresponding validated sample metadata exists, processing logic provides the validated sample metadata to report generator 170 to generate a report and enrich the data sample at block 340, such as generating tags and linking the tags to the data sample. On the other hand, if a corresponding validated sample metadata does not exist, processing logic generates request 125 to request information about the data sample at block 350.

At block 360, processing logic sends request 125 to job scheduler 130 that, in turn, sends request 125 to cloud service 132. Cloud service 132 processes the request and produces AI model response 140. At block 370, processing logic formats the response via response preprocessor 145, and provides the formatted response as sample metadata 148 to report generator 170 to generate report 180. In one embodiment, report generator 170 translates the metadata to tags and linking the tags to the data sample.

In addition, at block 380, processing logic provides the formatted sample metadata 148 to validation subsystem 150. At block 390, validation subsystem 150, validates the sample metadata and stores validated sample metadata 155 in sample metadata database 160 for subsequent use. In one embodiment, validated sample metadata 155 is used to train AI model 138.

FIG. 4 is a block diagram 400 that illustrates an example system for enriching a data sample with sample metadata in accordance with some embodiments of the present disclosure. In some embodiments, computer system 405 may perform some or all of the functionality described herein.

Computer system 405 includes processing device 410 and memory 415. Memory 415 stores instructions 420 that are executed by processing device 410. Instructions 420, when executed by processing device 410, cause processing device 410 to generate a request 440 to obtain information corresponding to a data sample 430. Processing device 410 provides request 440 to AI model 450 to produce sample metadata 460. The AI model is trained to analyze the data sample and generate the sample metadata. In turn, processing device 410 enriches data sample 430 using sample metadata 460.

FIG. 5 illustrates a diagrammatic representation of a machine in the example form of a computer system 500 within which a set of instructions, for causing the machine to perform any one or more of the methodologies discussed herein for enriching a data sample with sample metadata.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute data enrichment instructions 525, for performing the operations and steps discussed herein. For example, the data enrichment instructions 525 may include instructions for obtaining computer-readable text and an indication of a false positive detection of malicious behavior with respect to the computer-readable text by a cybersecurity system; obtaining, by a processing device and via an AI model trained to generate language, a reason for the false positive detection of the malicious behavior with respect to the computer-readable text by the cybersecurity system; and providing an indication of the reason for the false positive detection to a destination device.

The data storage device 518 may include a machine-readable storage medium 528 that stores the data enrichment instructions (e.g., software) embodying any one or more of the methodologies of functions described herein. The data enrichment instructions 525 may also reside, completely or at least partially, within the main memory 504 or within the processing device 502 during execution thereof by the computer system 500; the main memory 504 and the processing device 502 also constituting machine-readable storage media. The data enrichment instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “producing,” “enriching,” “translating,” “linking,” “validating,” “storing,” “receiving,” “determining,” “providing,” “identifying,” “training,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. §112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
generating a request to obtain information corresponding to a data sample;
using, by a processing device, an artificial intelligence (AI) model to produce sample metadata based on the request, wherein the artificial AI model is trained to analyze the data sample and generate the sample metadata; and
enriching the data sample, based on the sample metadata, to produce an enriched data sample.

2. The method of claim 1, wherein the data sample corresponds to a malicious data sample detected by a cybersecurity system and the sample metadata comprises at least one of a MITRE Tactic, Technique, or Procedure.

3. The method of claim 1, further comprising:
validating the sample metadata to produce a validated sample metadata; and
storing the validated sample metadata in a storage area.

4. The method of claim 3, further comprising:
receiving an inquiry to generate a subsequent request to provide subsequent information corresponding to a subsequent data sample;
determining whether the subsequent data sample corresponds to the validated sample metadata; and
in response to determining that the subsequent data sample corresponds to the validated sample metadata, providing the validated sample metadata as a response to the inquiry.

5. The method of claim 4, wherein the validated sample metadata comprises a first hash corresponding to the data sample, and wherein the determining further comprises:
identifying a second hash corresponding to the subsequent data sample; and
determining whether the first hash matches the second hash.

6. The method of claim 3, further comprising:
training the AI model utilizing the validated sample metadata.

7. The method of claim 1, wherein the enriching the data sample further comprises:
translating the sample metadata into tags; and
linking the tags to the data sample.

8. The method of claim 1, wherein the sample metadata comprises structured data in tabular form.

9. A system, comprising:
a memory; and
a processing device, that is operatively coupled to the memory, to:
generate a request to obtain information corresponding to a data sample;
produce sample metadata using an artificial intelligence (AI) model trained to analyze the data sample and generate the sample metadata; and
enrich the data sample, based on the sample metadata, to produce an enriched data sample.

10. The system of claim 9, wherein the data sample corresponds to a malicious data sample detected by a cybersecurity system and the sample metadata comprises at least one of a MITRE Tactic, Technique, or Procedure.

11. The system of claim 9, wherein the processing device further to:
validate the sample metadata to produce a validated sample metadata; and
store the validated sample metadata in a storage area.

12. The system of claim 11, wherein the processing device further to:
receive an inquiry to generate a subsequent request to provide subsequent information corresponding to a subsequent data sample;
determine whether the subsequent data sample corresponds to the validated sample metadata; and
in response to the subsequent data sample corresponding to the validated sample metadata, provide the validated sample metadata as a response to the inquiry.

13. The system of claim 12, wherein the validated sample metadata comprises a first hash corresponding to the data sample, and wherein the processing device further to:
identify a second hash corresponding to the subsequent data sample; and
determine whether the first hash matches the second hash.

14. The system of claim 11, wherein the processing device further to:
train the AI model utilizing the validated sample metadata.

15. The system of claim 9, wherein the processing device further to:
translate the sample metadata into tags; and
link the tags to the data sample.

16. The system of claim 9, wherein the sample metadata comprises structured data in tabular form.

17. A non-transitory computer readable medium, having instructions stored thereon which, when executed by a processing device, cause the processing device to:
generate a request to obtain information corresponding to a data sample;
produce, by the processing device, sample metadata using an artificial intelligence (AI) model trained to analyze the data sample and generate the sample metadata; and
enrich the data sample, based on the sample metadata, to produce an enriched data sample.

18. The non-transitory computer readable medium of claim 17, wherein the data sample corresponds to a malicious data sample detected by a cybersecurity system and the sample metadata comprises at least one of a MITRE Tactic, Technique, or Procedure.

19. The non-transitory computer readable medium of claim 17, wherein the processing device further to:
validate the sample metadata to produce a validated sample metadata; and
store the validated sample metadata in a storage area.

20. The non-transitory computer readable medium of claim 19, wherein the processing device further to:
receive an inquiry to generate a subsequent request to provide subsequent information corresponding to a subsequent data sample;
determine whether the subsequent data sample corresponds to the validated sample metadata; and
in response to the subsequent data sample corresponding to the validated sample metadata, provide the validated sample metadata as a response to the inquiry.
